(19) United States
(12) Patent Application Publication
(10) Pub. No.: US 2024/0104469 A1
(43) Pub. Date: Mar. 28, 2024

(54) Integrations Within Executed Workflow Interactions

(71) Applicant: Zoom Video Communications, Inc., San Jose, CA (US)

(72) Inventors: Jordan Douglas Betteridge, American Fork, UT (US); Patrick Alan Davis, Santa Clara, CA (US); Margaret Helen Munson, Portland, OR (US); Mohammed Akhil S, Bangalore (IN); Bhalahariharan V, Tiruppur (IN)

(21) Appl. No.: 17/954,880

(22) Filed: Sep. 28, 2022

(51) Int. Cl. G06Q 10/06

(52) U.S. Cl. CPC G06Q 10/0633

(57) ABSTRACT

A system provides integrated evaluations within executed workflow interactions. The system receives a query from a user device during an interaction between the user device and an agent device. The system determines a query intent, and based on a determination that a workflow is available in a database, executes the workflow. The system integrates an evaluation with in the workflow by transmitting a request for an input to the user device. The system displays rating options associated with the input in an interaction window. The system receives a rating selection based on one of the rating options and executes a response action corresponding to the rating selection.

### FIELD

This disclosure generally relates to workflow interactions, and in particular, executed workflow interactions integrated with evaluations.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a system for integrating an evaluation into an executed workflow interaction.

FIG. 5 is a flow diagram of an example of a method for a contact center agent workflow interaction.

FIG. 6 is a flow diagram of an example of a method for integrating an evaluation into an executed workflow interaction.

FIG. 7 is a flow diagram of an example of a method for integrating a star-rating evaluation into a workflow interaction.

FIG. 8 is a flow diagram of an example of a method for integrating a rescue action into an executed workflow interaction.

FIG. 9 is a flowchart of an example of a method for integrating a promotion action into an executed workflow interaction.

### DETAILED DESCRIPTION

Enterprise entities rely upon several modes of communication to support their operations, including telephone, email, internal messaging, and the like. These separate modes of communication have historically been implemented by service providers whose services are not integrated with one another. The disconnect between these services, in at least some cases, requires information to be manually passed by users from one service to the next. Furthermore, some services, such as telephony services, are traditionally delivered via on-premises systems, meaning that remote workers and those who are generally increasingly mobile may be unable to rely upon them. One type of system which addresses problems such as these includes a unified communications as a service (UCaaS) platform, which includes several communications services integrated over a network, such as the Internet, to deliver a complete communication experience regardless of physical location.

Software platforms, such as UCaaS platforms, can implement services usable for contact center engagements, for example, software services enabling communications over one or more modalities such as telephony, email, text messaging, chat, video conferencing, social media, or a combination thereof. Contact center engagements can be used to provide support actions in response to a request for support (e.g., technical support) or complaint. The support actions can be provided using one or more workflows. A workflow is a sequence of operations performed by the software platform to enable interactions between a user device and the software platform to provide support services to users and/or process information. Entities use evaluations, such as surveys or questionnaires, at the conclusion of a contact center engagement to obtain user responses to questions to understand the users' experiences with the provided support actions and to make improvements to enhance user satisfaction and retention.

Typical post-contact center engagement evaluations redirect the user to a separate or otherwise external service to complete the evaluation. In some examples, the post-contact center engagement evaluations are sent as a link in a separate email to the user which may be ultimately ignored by the user. By redirecting the user or using separate messaging, the continuity between the contact center engagement and the evaluation is lost. Since there is no continuity between the contact center engagement and the evaluation, these post-contact center engagement evaluations suffer from low response rates or the capture of inaccurate evaluation data due to a delay caused by the lack of continuity.

Implementations of this disclosure address problems such as these by integrating evaluations into an executed workflow that allows an entity to customize the text copy, responses, and custom action types for an evaluation. Dynamically integrating one or more evaluations into an executed workflow includes embedding evaluation questions into the workflow, where the evaluation questions are selected based on a determined context of the contact center engagement. The integration of the evaluation questions into the executed workflow allows the software user to instantly respond to the evaluation questions during the executed workflow without a separate or otherwise external service being necessary or otherwise involved. For example, if a software user indicates that they had a bad experience during a contact center engagement, the software platform can start a rescue program during the contact center engagement rather than at the conclusion of the contact center engagement. A rescue program can include one or more actions to enhance user satisfaction or retention. In an example, a rescue program can include an action such as offering a service, such as a discount or priority-level support. Since the evaluation is dynamically integrated into the workflow execution itself, users can complete the evaluation immediately within the workflow without being directed to an external service, thereby increasing the user response rate. The system thus eliminates the need to provide the user with an external link to an external service or send a separate email to the user to take the evaluation. Accordingly, they system provides a rapid mechanism to conduct an evaluation and obtain meaningful feedback, and provides a low pressure experience to the user.

The integrated evaluations may be implemented with a comments form component to collect feedback from the user. The feedback may be collected in the form of a text input, a voice input, or a video input. The comments form component can be displayed in an overlay, such that the comments form component is displayed over an interaction window of the integrated evaluation until the comments form is completed or exited. The integrated evaluation can be triggered based on a user response. For example, the system may display a support action based on the interaction and request input from the user as to whether the support action was helpful. If the user responds that the support action was helpful, the system will trigger the integrated evaluation. In another example, the system may trigger the integrated evaluation when the workflow is exited.

The integrated evaluation provides personalization, conditional logic, and advanced routing. In an integrated evaluation, the system may be configured to have a contact center agent, such as an automated agent, respond appropriately to whether the user indicates that they had a bad experience or a good experience. The integrated evaluation may be configured to trigger rescue and promotion programs. The integrated evaluation may be generated to define which users should be included in the program and what actions the system should take.

In an example, a rescue program may be triggered for users who had a negative experience and the system is configured to take an appropriate action. The rescue program may be based on a user profile and include one or more triggers and perform one or more actions, such as routing the interaction to a live support agent if the user is a priority user. If it is determined that the user had a good experience, a promotion program may be triggered to reward the user for a positive review or their loyalty. For example, the promotion program may include actions such as offering a service, such as a discount code for a future purchase or notifying the user about a new product that they may be interested in.

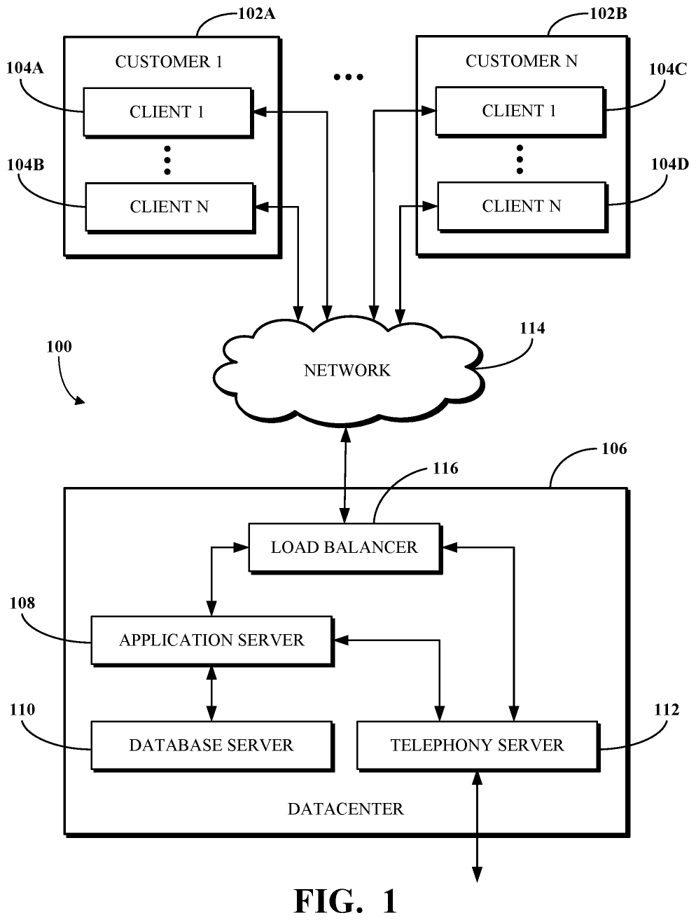

To describe some implementations in greater detail, reference is first made to examples of hardware and software structures used to implement dynamically integrated evaluations during the execution of a workflow. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The datacenter 106 may be a contact center. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and to clients of a customer, such as the clients 104A through 104B for the customer 102A or the clients 104C through 104D for the customer 102B. Some or all of the clients 104A through 104D may be voice over internet protocol (VOIP)-enabled devices configured to send and receive calls over a network 114. In particular, the telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The web zone receives traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

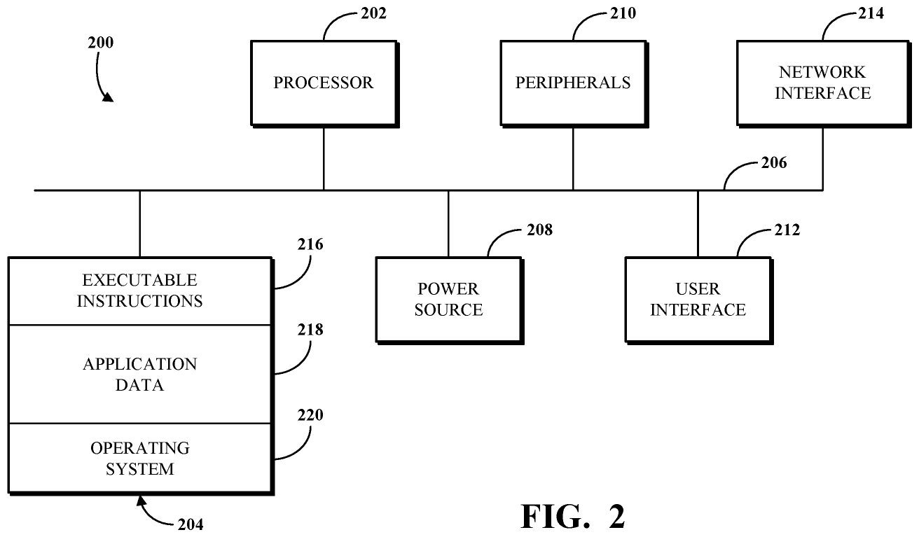

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

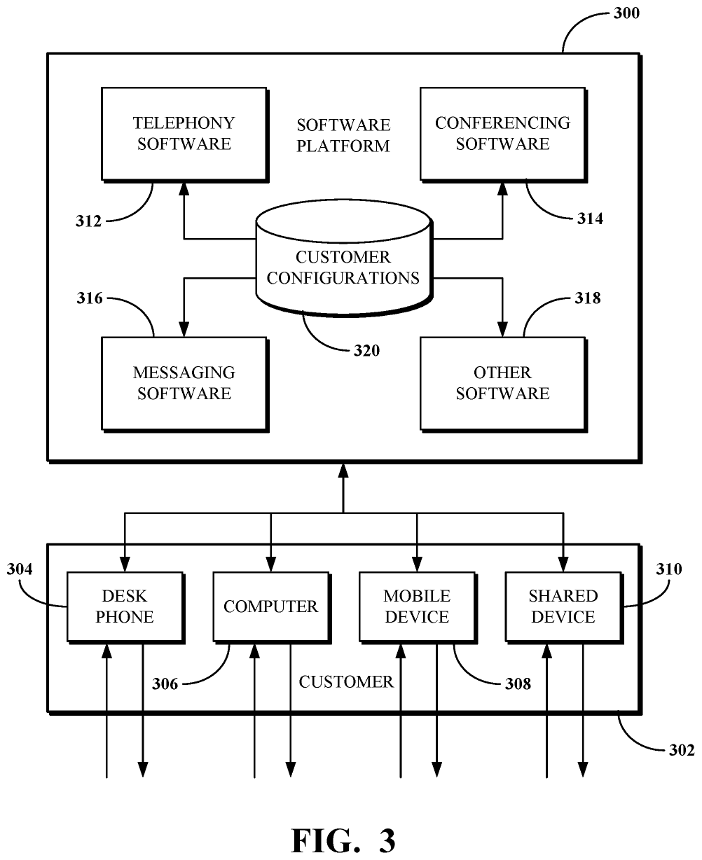

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients—a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can enable the integration of evaluations into executed workflow interactions.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

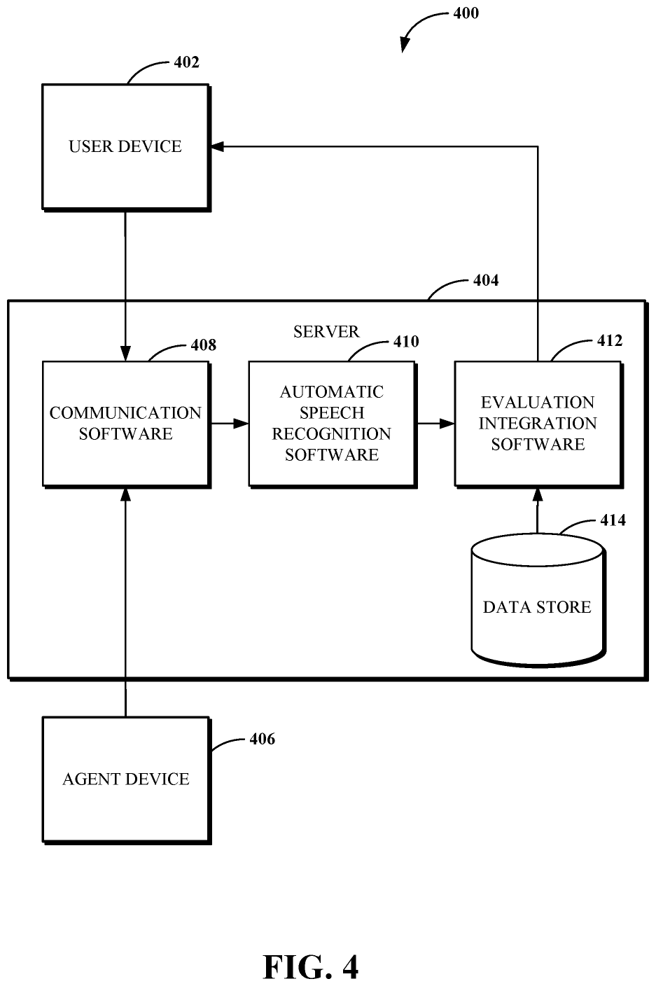

FIG. 4 is a block diagram of an example of a system 400 for integrating an evaluation into an executed workflow interaction. The system 400 includes a user device 402, a server 404, and an agent device 406. The user device 402 is a computing device configured for use by a user, such as to engage with a call center or contact center service. In some examples, the user device 402 may be a client device, such as any one of the clients 304 through 310 shown in FIG. 3, or a device other than a client device. The server 404 may be one or more of the servers 108 through 112 shown in FIG. 1, and may use communication software such as or similar to the software 312 through 318 shown in FIG. 3 to facilitate contact center engagements requested by user devices, such as the user device 402. The agent device 406 may be a device associated with (e.g., configured for use by an agent of) a call center or contact center. The agent device 406 may, for example, be a client device or a non-client device, for example, a desk phone, a computer, a mobile device, or a shared device. In some examples, the agent device 406 may be implemented as a hardware or software client.

The user device 402 and the agent device 406 are configured to communicate with each other via a communication software 408 of the server 404. The user device 402 and the agent device 406 may communicate with each other using communications that include telephone communications, VOIP communications, short messaging service (SMS) text communications, webchat communications, video chat communications, social media communications, email communications, and other digital service communications.

The agent device 406 is a device configured for use by a contact center agent. Where the contact center agent is a human, the agent device 406 is a device having a user interface. In some such cases, the agent device 406 may be a client device, for example, one of the clients 304 through 310, or a non-client device. In some such cases, the agent device 406 may be a server which implements software usable by one or more contact center agents to address contact center engagements requested by contact center users. Where the contact center agent is a non-human, the agent device 406 is a device that may or may not have a user interface. For example, in some such cases, the agent device 406 may be a server that implements software of or otherwise usable in connection with the contact center.

The server 404 is configured to monitor the communications between the user device 402 and the agent device 406 using the communication software 408. In some implementations, the server 404 may monitor the communications between the user device 402 and the agent device 406 using an automatic speech recognition (ASR) software 410. The ASR software 410 is or may otherwise use a transcription engine that is configured to monitor audio signals via the communication software 408. The ASR software 410 is configured to detect speech from audio signals received from the user device 402, audio signals received from the agent device 406, or both. The ASR software 410 is configured to convert the detected speech to text.

Evaluation integration software 412 of the server 404 is configured to analyze the text for one or more keywords to determine an intent of a query received from the user device 402. The evaluation integration software 412 may detect a keyword by comparing the text to a list of keywords stored in a data store 414 of the server 404. The list of keywords may include specific words, semantic concepts, or both. The evaluation integration software 412 may be configured to determine a context of one or more keywords. The context of the one or more keywords may be determined using a machine learning (ML) model that can determine a context of a keyword by analyzing data including data associated with a neighboring word range of the keyword, location data to determine a geographic region of the user, social media data of the user, spending data of the user, or any combination thereof. Based on a detection of one or more keywords, a context of the keywords, or both, the evaluation integration software 412 may retrieve an evaluation from the data store 414 and execute the evaluation by integrating the evaluation (e.g., evaluation questions) into the executed workflow such that the evaluation questions are embedded within the interaction with the user device 402. The evaluation questions are embedded into the executed workflow based on the context of the one or more keywords in one or more responses received from the user device 402. For example, the integration of the evaluation into the executed workflow may be triggered by the detection of a keyword, or a determined context thereof, in a response received from the user device 402. The integrated evaluation workflow interaction may be updated such that the selection of evaluation questions is based on the context of the one or more keywords in one or more responses received from the user device 402. The server 404 may transmit one or more evaluation requests integrated within the workflow interaction to the user device 402 via a graphical user interface (GUI) output.

In an example, the GUI output may be displayed on a GUI of the user device 402 in an interaction window. The interaction window is used to display an interaction between the user device 402 and the agent device. The interaction may be a contact center engagement, such as a conversation, for example, using chat messaging, text messaging, video messaging, or voice messaging.

In an example use case, a user may initiate a contact center engagement to obtain a remedy for a defective product. The user transmits a query, via the user device 402, to the contact center to initiate a contact center engagement with the agent device 406. The server 404 of the contact center analyzes the query to determine one or more keywords, a context thereof, or both. In this example, the server 404 retrieves a workflow associated with the defective product and executes the workflow to enable an interaction between the user device 402 and the agent device 406. During the interaction between the user device 402 and the agent device 406, the server 404 triggers an evaluation based on a response from the user device 402. For example, if the response from the user device 402 is “Yes” to the question “Was the solution helpful?,” the server 404 may trigger an evaluation. The server 404 retrieves evaluation questions from a database and integrates the evaluation questions into the executed workflow such that the user device 402 can respond within the workflow interaction. For example, the evaluation question may be, “How would you rate this experience?” and provide options from 1-star to 5-stars. The server 404 obtains the responses from the user device 402 and can base the evaluation questions on the context of the workflow interaction and/or one or more detected keywords in the workflow interaction. Upon conclusion of the integrated evaluation, the server 404 can perform an action such as a rescue action or a promotion action, for example, based on the data obtained during the integrated evaluation.

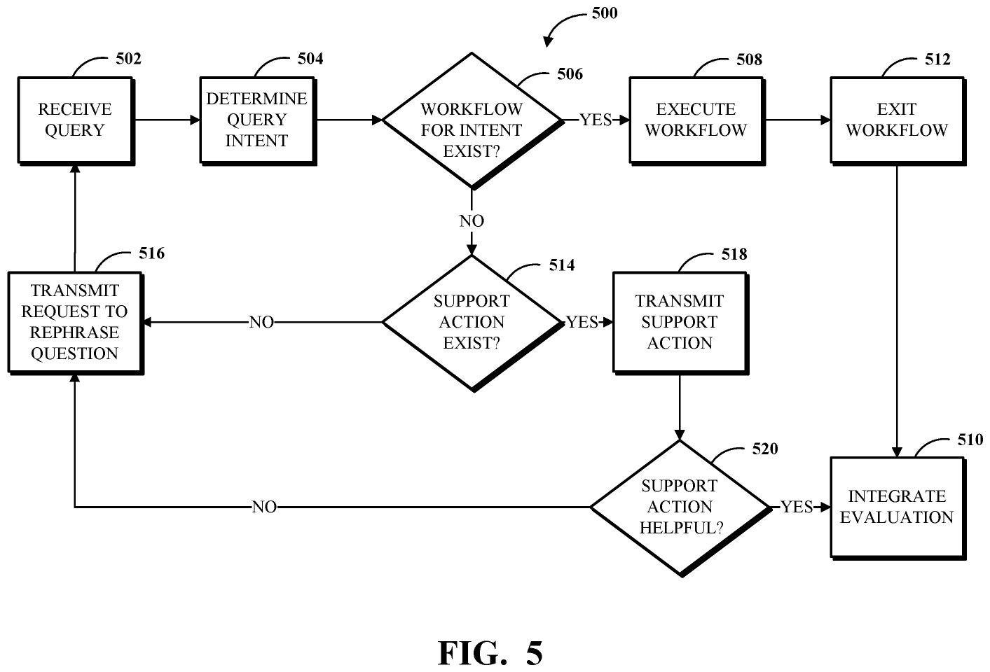

To further describe some implementations in greater detail, reference is next made to examples of techniques which may be performed by or using workflow interactions with integrated evaluations. FIGS. 5-9 are flowcharts of examples of methods for integrating an evaluation into a workflow interaction. The methods can be executed using computing devices, such as the systems, hardware, and software described with respect to FIGS. 1-4. The methods can be performed, for example, by executing a machine-readable program or other computer-executable instructions, such as routines, instructions, programs, or other code. The steps, or operations, of the methods or other techniques, processes, or algorithms described in connection with the implementations disclosed herein can be implemented directly in hardware, firmware, software executed by hardware, circuitry, or a combination thereof.

For simplicity of explanation, the methods are depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

FIG. 5 is a flow diagram of an example of a method 500 for a contact center agent workflow interaction. The contact center agent may be a client device or a client application running on a computing device, such as server 404 shown in FIG. 4. At 502, the method 500 includes receiving a query by a device of a contact center agent, such as the agent device 406 shown in FIG. 4. The query is received from a user device, such as user device 402 shown in FIG. 4. The user device transmits the query to initiate a contact center engagement with the device of the contact center agent. The query may be a text input, a voice input, or a video input.

At 504, the method 500 includes determining a query intent. Determining the query intent may include analyzing the text for one or more keywords. A keyword may be detected by comparing the text to a list of keywords stored in a data store, such as data store 414 shown in FIG. 4. The list of keywords may include specific words, semantic concepts, or both. Determining the query intent may include determining a context of one or more keywords, for example, by using an ML model. The ML model can be used to determine the context of one or more keywords by analyzing data associated with a neighboring word range of the one or more keywords, location data to determine a geographic region of the user, social media data to determine one or more attributes of the user, spending data of the user, order history of the user, or any combination thereof.

At 506, the method 500 includes determining whether a workflow for the determined intent exists, for example, in a database of the system. The workflow may be created by a contact center employee and stored in the database. Determining whether a workflow exists may include querying the database based on the determined intent. For example, each workflow that is stored in the database may include one or more identifiers. If an identifier of a workflow matches a determined intent, the system determines that a workflow for the determined intent exists in the database. For example, if it is determined that the intent of the query is associated with a technical issue with a product, the system will search for a workflow that has an identifier that is associated with the product, one or more technical issues related to the product, or both.

If it is determined that a workflow for the determined intent exists in the database, the workflow is retrieved as an output of the query and executed at 508. Execution of the workflow enables an interaction, such as a conversation, between the user device and the system. The interaction may be a text interaction, a voice interaction, or a video interaction. At 510, an evaluation is integrated into the workflow interaction. Integrating the evaluation into the workflow interaction includes dynamically embedding evaluation questions into the workflow to obtain responses from the user device and collect data. The system is configured to determine the context of the responses obtained from the user device and provide follow up questions and/or support actions based on the context of the responses. The context of the responses may be determined by analyzing keywords and using an ML model. In some examples, the workflow may be exited at 512 prior to initiating the evaluation.

If it is determined that a workflow for the determined intent does not exist in the database, a determination of whether a support action exists is made at 514. Determining whether a support action exists includes querying a database. The query is based on the determined query intent. If it is determined that a support action does not exist, the method 500 includes transmitting a request to the user device at 516. The request may be a request to rephrase the question. If it is determined that a support action exists at 514, the method 500 includes retrieving the support action from the database and transmitting the support action to the user device at 518. At 520, the method 500 includes determining whether the support action is helpful, for example, by requesting feedback from the user. If it is determined that the feedback is helpful, an evaluation is integrated into the workflow interaction at 510. If it is determined that the feedback is not helpful, a request to rephrase the question is transmitted to the user device at 516.

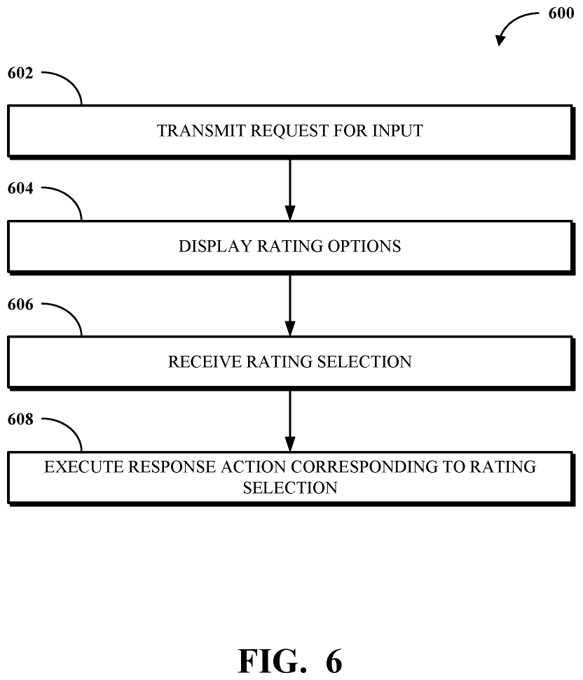

FIG. 6 is a flow diagram of an example of a method 600 for integrating an evaluation into an executed workflow interaction, such as in operation 510 shown in FIG. 5. Integrating the evaluation into the workflow enables a conversation between a contact center agent via an agent device and a user via a user device. The evaluation can be based on the conversation between the contact center agent via the agent device and the user via the user device within the workflow. For example, the evaluation questions can be updated based on one or more user responses. The evaluation may enable the system to obtain a comment from the user via the user device. The comment may be a text comment, an audio comment, or a video comment that provides additional information that cannot be obtained via the evaluation questions alone. At 602, the method 600 includes transmitting a request for input to the user device. The request may be transmitted from a server, such as server 404 shown in FIG. 4.

At 604, the method 600 includes displaying one or more rating options on a display of the user device. The rating options can be a star-rating, a binary rating, a numeric rating, or another type of rating. An example star-rating evaluation may include rating options ranging from a 1-star rating to a 5-star rating, where the 1-star rating is the lowest rating and the 5-star rating is the highest rating. An example binary rating evaluation includes two options and can include a yes-or-no question or another question that has two options for responses. An example numeric rating evaluation may include rating options from 1 to 10, where 1 is the lowest rating and 10 is the highest rating.

At 606, the method 600 includes receiving a rating selection. The rating selection is based on one of the displayed rating options. The rating selection is received from the user device based on an input from the user. The input may be a touch input on the display of the user device, a voice input obtained by one or more microphones of the user device, or a text input from a keyboard of the user device. The keyboard of the user device may be a hardware keyboard or a software keyboard displayed on the display of the user device.

At 608, the method 600 includes executing a response action corresponding to the rating selection. Executing the response action may include executing a first action, such as a promotion action, based on the received rating selection being the highest rating selection, for example, a 5-star rating selection. Executing the first action can include transmitting a product suggestion to the user device. The product suggestion can be determined based on a user profile, keywords detected in the user responses, or both. The user profile can include information associated with the user of the user device, such as name, geographic location, purchase history, search history, social media data, or any combination thereof. The product suggestion may be transmitted based on a determination that the interaction is a first time interaction of a user of the user device, a comment was obtained from the user via the user device, or both. Executing the first action can include transmitting a service offer based on a determination that the user is a priority user. The service offer can include an offer such as a discount code, a complimentary service, or the like.

Executing the response action may include executing a second action, such as a rescue action, based on the received rating selection being less than or equal to a threshold, for example, a 2-star rating selection. Executing the second action can include transmitting a service offer to the user device. The service offer may be transmitted based on a determination that the interaction is a first time interaction of a user of the user device, a comment was obtained from the user via the user device, or both. Executing the second action can include initiating a communication session with a live agent at the contact center based on a determination that the user is a priority user.

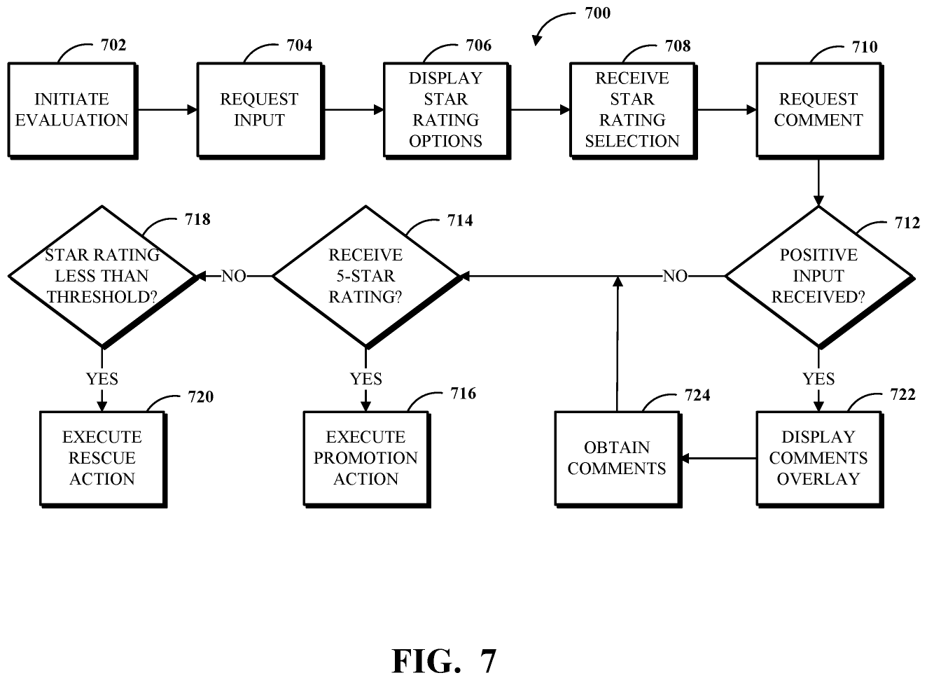

FIG. 7 is a flow diagram of an example of a method 700 for integrating a star rating evaluation into an executed workflow interaction. The star rating evaluation may be based on a star rating scale with any number of stars. In this example, the star rating evaluation may be based on a 5-star rating scale where a 5-star rating is the highest rating and a 1-star rating is the lowest rating. At 702, the method 700 includes initiating an evaluation. The evaluation is integrated into a workflow as described with reference to operation 510 shown in FIG. 5.

At 704, the method 700 includes transmitting a request for input. The request for input may include questions, such as “Was the solution helpful?” or “How would you rate your experience today?” that are displayed on a display of a user device. The questions can be displayed in an interaction window on the display of the user device. The interaction window is an area of the display used to display the evaluation integrated into the workflow and enables an interaction, such as a conversation, between the user via the user device and the contact center agent via an agent device.

At 706, the method 700 includes displaying star rating options on the display of the user device. The star rating options are displayed in the interaction window of the display. In this example, the star rating options from a 1-star rating to a 5-star rating are displayed in the interaction window of the display.

At 708, the method 700 includes receiving a star rating selection. The rating selection is based on one of the displayed star rating options. The star rating selection is received from the user device based on an input from the user. The input may be a touch input on the interaction window of the display of the user device, a voice input obtained by one or more microphones of the user device, or a text input from a keyboard of the user device. The keyboard of the user device may be a hardware keyboard or a software keyboard.

At 710, the method 700 includes transmitting a request for comment to the user device. The request for comment is displayed in the interaction window of the display. The request for comment may be a question to the user, such as “Will you provide a comment?” or “Can you provide some thoughts on your experience?”

At 712, the method 700 includes determining whether a positive input is received in response to the request for comment. A positive input is an input that indicates that the user will provide a comment. Examples of a positive input include “Yes,” “Absolutely,” “I would be happy to,” or the like. A negative input is an input that indicates that the user will not provide a comment. Examples of a negative input include “No,” “Not today,” “Never,” or the like.

If it is determined at 712 that a positive input is not received (i.e., a negative input is received), the method 700 includes determining whether a 5-star rating selection is received at 714.

If it is determined at 714 that a 5-star rating selection is received, the method 700 includes executing a promotion action at 716. A promotion action is a response action that is triggered when the user selects a positive rating selection. The promotion action may be used to reward a user for providing a positive rating selection.

If it is determined at 714 that a 5-star rating selection is not received, the method 700 includes determining whether the received star rating selection is less than a threshold at 718. The threshold may be set to be any rating selection that triggers the execution of a response action. In this example, a 3-star rating selection is set as a threshold rating selection for executing a response action. If it is determined at 718 that a 1-star or a 2-star rating selection is received, the method 700 includes executing a rescue action at 720. A rescue action is a response action that is triggered when the user selects a negative rating selection. The rescue action may be used to appease and retain the user as a customer in response to receiving the negative rating selection.

If it is determined at 712 that a positive input is received, the method 700 includes displaying a comments overlay at 722. The comments overlay is a comments form component of the integrated evaluation that is displayed over the interaction window until a comments form associated with the comments form component is completed or exited by the user.

At 724, the method 700 includes obtaining comments via the comments overlay. Upon obtaining the comments via the comments overlay, the method 700 continues to operation 714. The comments can be obtained via the user device as a text input, a voice input, or a video input. The system may detect that the comments include one or more keywords determine the context of the one or more keywords using an ML model. The ML model can be used to determine whether the comment is a positive comment or a negative comment. Based on a detection of one or more keywords, a context of the keywords, or both, the system may determine a support action by querying a database. If a support action exists in the database, the system transmits the support action to the user device. If a support action does not exist in the database, the system stores the comments in the database.

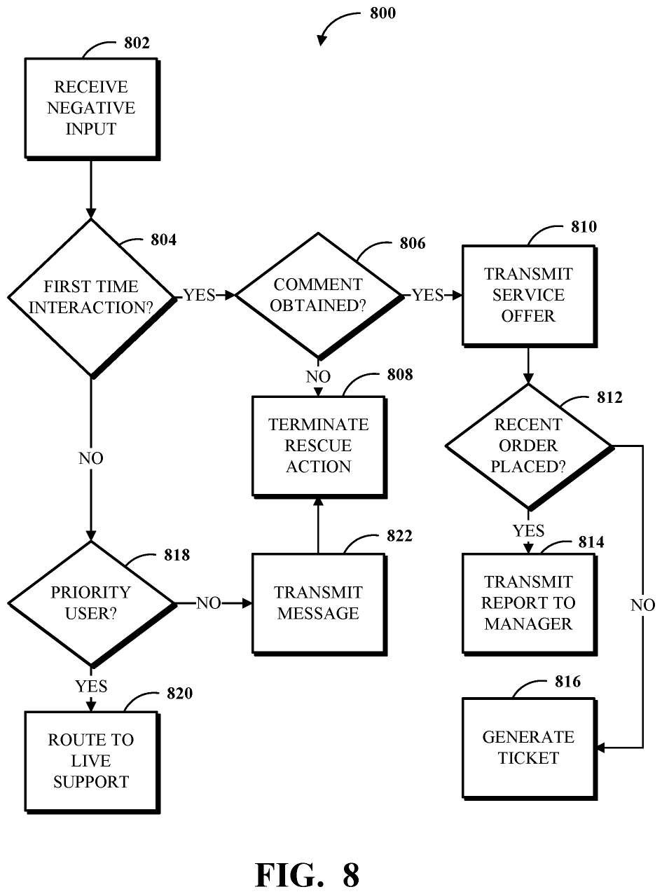

FIG. 8 is a flow diagram of an example of a method 800 for integrating a rescue action into an executed workflow interaction. At 802, the method 800 includes receiving a negative input. The negative input may be received via the user device in response to an evaluation question or as a comment. In an example, an evaluation question may be displayed on a display of the user device with two or more response options. For example, the evaluation question may ask “Are you satisfied with the solution?” and provide a first response option as “Yes” and a second response option as “No.” A negative response to the evaluation question may be “No” or a comment that has a determined context that the user is dissatisfied with the support action.

At 804, the method 800 includes determining whether the interaction is a first time interaction of a user of the user device. Determining whether the interaction is a first time interaction includes querying a database to determine whether a user account associated with the user indicates any previous interactions with the system.

If it is determined at 804 that the interaction is a first time interaction, the method 800 includes determining whether a comment from the user was obtained at 806 via the user device. If a comment from the user was not obtained, the method 800 includes terminating the rescue action at 808.

If it is determined at 806 that a comment from the user was obtained, the method 800 includes transmitting a service offer at 810. The service offer may include a discount code, a rebate, a complimentary service, a complimentary product, or the like. The service offer may be determined based on a determined context of the interaction, a user profile, a user purchase history, a user search history, or any combination thereof.

At 812, the method 800 incudes determining whether a recent order was placed by the user. If it is determined that a recent order was placed by the user at 812, the method 800 includes transmitting a report to a device of a manager of the contact center. The manager may be a manager of a particular department at the contact center. The report may include data associated with one or more negative responses that can be used to improve future user experiences. If it is determined that a recent order was not placed by the user at 812, the method 800 includes generating a ticket at 816 and transmitting the ticket to one or more devices of a customer support team of the contact center.

If it is determined at 804 that the interaction is not a first time interaction, the method 800 includes determining whether the user is a priority user at 818. A priority user is a user that has earned an enhanced level of service, for example, based on a spending history that indicates a high level of spending, a length of time as a user, a number of interactions with the system, or any combination thereof. If it is determined at 818 that the user is a priority user, the method 800 includes routing the interaction to a live support agent at 820. If it is determined at 818 that the user is not a priority user, the method 800 includes transmitting a message at 822 and terminating the rescue action at 808. The message may include an apology.

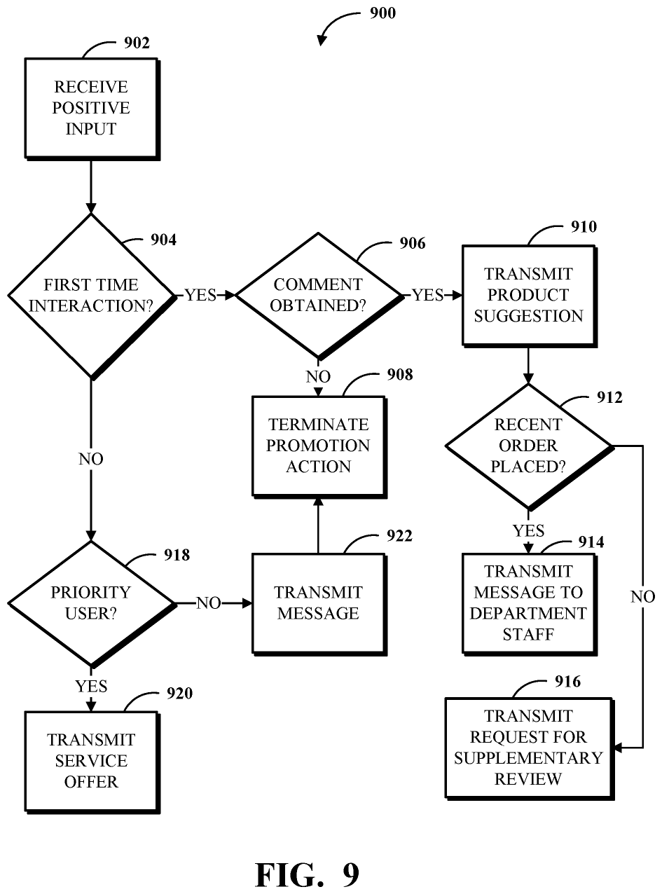

FIG. 9 is a flowchart of an example of a method 900 for integrating a promotion action into an executed workflow interaction. At 902, the method 900 includes receiving a positive input. The positive input may be received via the user device in response to an evaluation question or as a comment. In an example, an evaluation question may be displayed on a display of the user device with two or more response options. For example, the evaluation question may ask “How was your experience today?” and provide a first response option as “Good” and a second response option as “Bad.” A positive response to the evaluation question may be “Good” or a comment that has a determined context that the user is satisfied with the experience.

At 904, the method 900 includes determining whether the interaction is a first time interaction of a user of the user device. Determining whether the interaction is a first time interaction includes querying a database to determine whether a user account associated with the user indicates any previous interactions with the system.

If it is determined at 904 that the interaction is a first time interaction, the method 900 includes determining whether a comment from the user was obtained at 906 via the user device. If a comment from the user was not obtained, the method 900 includes terminating the promotion action at 908.

If it is determined at 906 that a comment from the user was obtained via the user device, the method 900 includes transmitting a product suggestion at 910. The product suggestion may be determined based on a determined context of the interaction, a user profile, a user purchase history, a user search history, or any combination thereof. The system may use an ML algorithm to determine the product suggestion.

At 912, the method 900 incudes determining whether a recent order was placed by the user. If it is determined that a recent order was placed by the user at 912, the method 900 includes transmitting a message to the staff of a department at the contact center. An example message may be a congratulatory message to the staff of a department at the contact center for a job well done. If it is determined that a recent order was not placed by the user at 912, the method 900 includes transmitting a request to the user for a supplementary review at 916 to obtain additional data that can be used for future evaluations.

If it is determined at 904 that the interaction is not a first time interaction, the method 900 includes determining whether the user is a priority user at 918. If it is determined at 918 that the user is a priority user, the method 900 includes transmitting a service offer at 920. The service offer may include a discount code, a rebate, a complimentary service, a complimentary product, or the like. The service offer may be determined based on a determined context of the interaction, a user profile, a user purchase history, a user search history, or any combination thereof. If it is determined at 918 that the user is not a priority user, the method 900 includes transmitting a message at 922 and terminating the promotion action at 908. An example of the message may be a thank you message.

An aspect may include a method for integrating an evaluation into an executed workflow. The method may include receiving a query from a user device. The query may be received during an interaction between the user device and an agent device of a contact center. The method may include determining a query intent based on the query. The method may include determining whether a workflow associated with the query intent is available in a database. The method may include executing the workflow based on a determination that the workflow is available in the database. The method may include integrating the evaluation into the workflow. Integrating the evaluation into the workflow may include transmitting a request for an input to the user device. Integrating the evaluation into the workflow may include displaying rating options associated with the input in an interaction window. Integrating the evaluation into the workflow may include receiving a rating selection based on one of the rating options. Integrating the evaluation into the workflow may include executing a response action corresponding to the rating selection.

An aspect may include a system for integrating an evaluation into an executed workflow. The system may include an agent device of a contact center agent and a server. The server may be configured to receive a query from a user device. The server may receive the query from the user device during an interaction between the user device and the agent device. The server may be configured to determine a query intent based on the query. The server may be configured to determine whether a workflow associated with the query intent is available in a database. The server may be configured to execute the workflow based on a determination that the workflow is available in the database. The server may be configured to integrate the evaluation into the workflow. To integrate the evaluation into the workflow, the server may be further configured to transmit a request for an input to the user device. To integrate the evaluation into the workflow, the server may be further configured to display rating options associated with the input in an interaction window. To integrate the evaluation into the workflow, the server may be further configured to receive a rating selection based on one of the rating options. To integrate the evaluation into the workflow, the server may be further configured to execute a response action corresponding to the rating selection.

An aspect may include a non-transitory computer-readable medium comprising stored instructions that when executed by a processor cause the processor to perform operations. The operations may include receiving a query from a user device. The query may be received during an interaction between the user device and an agent device of a contact center agent. The operations may include determining a query intent based on the query. The operations may include determining whether a workflow associated with the query intent is available in a database. The operations may include executing the workflow based on a determination that the workflow is available in the database. The operations may include integrating an evaluation into the workflow. Integrating the evaluation into the workflow may include transmitting a request for an input to the user device. Integrating the evaluation into the workflow may include displaying rating options associated with the input in an interaction window. Integrating the evaluation into the workflow may include receiving a rating selection based on one of the rating options. Integrating the evaluation into the workflow may include executing a response action corresponding to the rating selection.

In one or more aspects, executing the response action may include executing a first action based on the received rating selection being a highest rating. In one or more aspects, executing the response action may include transmitting a product suggestion based on a determination that the interaction is a first time interaction of a user of the user device and a comment was obtained from the user via the user device. In one or more aspects, executing the response action may include transmitting a service offer based on a determination that the user is a priority user. In one or more aspects, executing the response action may include executing a second action when the received rating selection is less than a threshold. In one or more aspects, executing the response action may include transmitting a service offer based on a determination that the interaction is a first time interaction of a user of the user device and a comment was obtained from the user via the user device. In one or more aspects, executing the response action may include initiating a communication session with a live agent based on a determination that the user is a priority user. In one or more aspects, integrating the evaluation may enable a conversation between the contact center agent via the agent device and a user via the user device. In one or more aspects, the evaluation may be based on a conversation between the contact center agent via the agent device and a user via the user device within the workflow.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method comprising:
receiving, during an interaction between a user device and an agent device of a contact center, a query from the user device;
determining a query intent based on the query;
determining whether a workflow associated with the query intent is available in a database;
based on a determination that the workflow is available in the database, executing the workflow; and
integrating an evaluation into the workflow by:
transmitting a request for an input to the user device;
displaying rating options associated with the input in an interaction window;
receiving a rating selection based on one of the rating options; and
executing a response action corresponding to the rating selection.

2. The method of claim 1, wherein executing the response action comprises executing a first action based on the received rating selection being a highest rating.

3. The method of claim 1, wherein executing the response action comprises:
executing a first action based on the received rating selection being a highest rating; and
transmitting a product suggestion based on a determination that the interaction is a first time interaction of a user of the user device and a comment was obtained from the user via the user device.

4. The method of claim 1, wherein executing the response action comprises:
executing a first action based on the received rating selection being a highest rating; and
transmitting a service offer based on a determination that the user is a priority user.

5. The method of claim 1, wherein executing the response action comprises executing a second action when the received rating selection is less than a threshold.

6. The method of claim 1, wherein executing the response action comprises:
executing a second action when the received rating selection is less than a threshold; and
transmitting a service offer based on a determination that the interaction is a first time interaction of a user of the user device and a comment was obtained from the user via the user device.

7. The method of claim 1, wherein executing the response action comprises:
executing a second action when the received rating selection is less than a threshold; and
initiating a communication session with a live agent based on a determination that the user is a priority user.

8. The method of claim 1, wherein integrating the evaluation enables a conversation between the contact center agent via the agent device and a user via the user device.

9. The method of claim 1, wherein the evaluation is based on a conversation between the contact center agent via the agent device and a user via the user device within the workflow.

10. A system comprising:
an agent device of a contact center agent; and
a server configured to:
receive, during an interaction between a user device and the agent device, a query from the user device;
determine a query intent based on the query;
determine whether a workflow associated with the query intent is available in a database;
based on a determination that the workflow is available in the database, execute the workflow; and
integrate an evaluation into the workflow,
wherein the server is further configured to:
transmit a request for an input to the user device;
display rating options associated with the input in an interaction window;
receive a rating selection based on one of the rating options; and
execute a response action corresponding to the rating selection.

11. The system of claim 10, wherein the response action is a first action based on the received rating selection being a highest rating.

12. The system of claim 10, wherein the server is further configured to:
execute a first action based on the received rating selection being a highest rating; and
transmit a product suggestion based on a determination that the interaction is a first time interaction of a user of the user device and a comment was obtained from the user via the user device.

13. The system of claim 10, wherein the server is further configured to:
execute a first action based on the received rating selection being a highest rating; and
transmit a service offer based on a determination that the user is a priority user.

14. The system of claim 10, wherein the response action is a second action based on the received rating selection being less than a threshold.

15. The system of claim 10, wherein the server is further configured to:
execute a second action when the received rating selection is less than a threshold; and
transmit a service offer based on a determination that the interaction is a first time interaction of a user of the user device and a comment was obtained from the user via the user device.

16. The system of claim 10, wherein the server is further configured to:
execute a second action when the received rating selection is less than a threshold; and
initiate a communication session with a live agent based on a determination that the user is a priority user.

17. A non-transitory computer-readable medium comprising stored instructions that when executed by a processor cause the processor to perform operations comprising:
receiving, during an interaction between a user device and an agent device of a contact center agent, a query from the user device;
determining a query intent based on the query;
determining whether a workflow associated with the query intent is available in a database;
based on a determination that the workflow is available in the database, executing the workflow; and
integrating an evaluation into the workflow by:
transmitting a request for an input to the user device;
displaying rating options associated with the input in an interaction window;
receiving a rating selection based on one of the rating options; and
executing a response action corresponding to the rating selection.

18. The non-transitory computer-readable medium of claim 17, wherein executing the response action includes executing a first action based on the received rating selection being a highest rating.

19. The non-transitory computer-readable medium of claim 17, wherein executing the response action comprises:
executing a first action based on the received rating selection being a highest rating; and
transmitting a product suggestion based on a determination that the interaction is a first time interaction of a user of the user device and a comment was obtained from the user via the user device.

20. The non-transitory computer-readable medium of claim 17, wherein executing the response action comprises:
executing a second action when the received rating selection is less than a threshold; and
transmitting a service offer based on a determination that the interaction is a first time interaction of a user of the user device and a comment was obtained from the user via the user device.
